(19) United States
(12) Patent Application Publication
(10) Pub. No.: US 2010/0001709 A1
(43) Pub. Date: Jan. 7, 2010

(54) SYSTEM TO GENERATE A REFERENCE FOR A CHARGE PUMP AND ASSOCIATED METHODS

(76) Inventors: John E. Barth, JR., Williston, VT (US); Charlie C. Hwang, Hopewell Junction, NY (US); Paul D. Muench, Poughkeepsie, NY (US); Donald W. Plass, Poughkeepsie, NY (US); Michael Sperling, Poughkeepsie, NY (US)

Correspondence Address: INTERNATIONAL BUSINESS MACHINES CORPORATION;Richard Lau, IPLAW DEPARTMENT / Bldg 008-2, 2455 SOUTH ROAD - MS P386, POUGHKEEPSIE, NY, 12601, US

(21) Appl. No.: 12/168,133

(22) Filed: Jul. 6, 2008

(51) Int. Cl. G05F 3/18

(52) U.S. Cl. 323/313

(57) ABSTRACT

A system to generate a reference for a charge pump may include a diode-connected transistor providing a reference voltage, and an output transistor. The system may also include a reference circuit to provide a current that is substantially temperature insensitive and the reference circuit delivers the current across the diode-connected transistor thereby enabling the reference voltage to move with processing of the diode-connected transistor.

### FIELD OF THE INVENTION

The invention relates to the field of charge pumps, and, more particularly, to current references used in charge pumps.

### RELATED APPLICATIONS

This application contains subject matter related to the following co-pending application entitled “System to Evaluate a Voltage in a Charge Pump and Associated Methods” and having an attorney docket number of POU920080089US1, the entire subject matter of which is incorporated herein by reference in its entirety. The aforementioned application is assigned to the same assignee as this application, International Business Machines Corporation of Armonk, N.Y.

### BACKGROUND OF THE INVENTION

A charge pump is an electrical circuit that can take in a direct current (“DC”) voltage and generate an output voltage that is higher than the original. An alternate configuration is a negative charge pump which generates a voltage that can be below ground.

A prior art embedded dynamic random access (“eDRAM”) memory cell is illustrated in FIG. 1. During a write to this memory cell, a high voltage is put on the ‘Gate’ 15 and the voltage on the ‘Node’ 11 gets stored by the capacitor 13. The higher the voltage, the faster the capacitor will be charged. A charge pump can be used to generate this high voltage.

During a read of the memory cell, a high voltage is put on the ‘Gate’ 15 and the voltage that is stored on the capacitor 13 can be read at the ‘Node’ 11. The higher the voltage, the faster the read of the memory cell.

During standby, the gate voltage will be driven low to turn off the N-Type transistor 17. Leakage thru this transistor 17 will drain the capacitor. A charge pump can be used to generate this negative voltage to minimize the leakage.

With reference to FIGS. 2-4, in a typical positive charge pump, the positive charge pump will create a new voltage that is higher than the power supply (called VPP). A comparison is usually done to figure out whether the output voltage is high enough. The compare is usually made between some reference voltage and a divided down output voltage.

If the output voltage is too low, the pump can be activated. Looking at FIG. 2, we see P-type 19a-19c and N-type 21 transistors which act as digital switches in FIGS. 3 & 4. A shorted connection refers to the transistor switch being closed while an open connection refers to the transistor switch being open. There are two phases of operation of the charge pump, which are charging and pumping. During charging shown in FIG. 3, the power supply voltage VDD appears across the capacitor 23. During pumping, the charge built up across the capacitor 23 can be discharged into the output VPP. Together with the comparison and reference voltage these components may make up a charge pump system.

As noted above, voltage generator circuits are used to generate DC voltages above the value of the power supply. This is usually done thru the use of charge pumping circuits that compare the output voltage (or usually a divided down version of that voltage) to a reference.

The reference is typically a bandgap generator or some other reference that does not change with process, voltage, and temperature (“PVT”). For example, U.S. Pat. No. 7,038,945 to Kessenich may disclose a charge pump system that uses a bandgap generator to generate its voltage. Similarly, U.S. Pat. No. 6,507,237 to Hsu et al. also uses a bandgap generator, but may also require an extra pump to generate the voltage necessary to run the bandgap.

### SUMMARY OF THE INVENTION

In view of the foregoing background, it is an object of the invention to generate a current reference for a charge pump.

This and other objects, features, and advantages in accordance with the invention are provided by a system to generate a reference for a charge pump. The system may include a diode-connected transistor providing a reference voltage, and an output transistor providing a reference current. The system may also include a reference circuit to provide a current that is substantially temperature insensitive. The reference circuit may deliver the current across the diode-connected transistor thereby enabling the reference voltage to move with processing of the diode-connected transistor.

The system may further include a mirroring circuit to mirror the current to the output transistor. The mirroring circuit may comprise positive-type field-effect transistors.

The diode-connected transistor may comprise a field-effect transistor. The diode-connected transistor may comprise a dynamic random access memory transistor.

With additional reference to FIG. 6, the reference circuit may comprise a bandgap arrangement of transistors and a resistor in parallel with each of the bandgap arrangement of transistors to reduce at least one of process, voltage, and temperature sensitivity of the current. The reference circuit's bandgap arrangement of transistors may comprise negative-type transistors.

The reference circuit's bandgap arrangement of transistors and respective parallel resistors may sum the current. The reference circuit's resistors may compensate for temperature dependence of transistor voltage thresholds of the bandgap arrangement of transistors.

Another aspect of the invention is a method to generate a current reference for a charge pump. The method may include supplying a reference voltage via a diode-connected transistor. The method may also include providing a current that is substantially temperature insensitive across the diode-connected transistor thereby enabling the reference voltage to move with processing of the diode-connected transistor.

The method may further include mirroring the current to the output transistor. The method may also include changing the reference voltage at the diode-connected transistor when a threshold in the diode-connected transistor changes.

The method may further include reducing at least one of process, voltage, and temperature sensitivity of the current via a bandgap arrangement of transistors and a resistor in parallel with each of the bandgap arrangement of transistors. The method may also include summing the current with the bandgap arrangement of transistors and the respective parallel resistors. The method may additionally include compensating for temperature dependence of transistor voltage thresholds of the bandgap arrangement of transistors with the resistors.

### BRIEF DESCRIPTION OF THE DRAWINGS

FIG. 1 is a schematic block diagram of a prior art eDRAM charge pump.

FIG. 2 is a schematic block diagram of a prior art positive charge pump.

FIG. 3 is a schematic block diagram of the prior art positive charge pump of FIG. 2 charging.

FIG. 4 is a schematic block diagram of the prior art positive charge pump of FIG. 2 pumping.

FIG. 5 is a schematic block diagram of a system to generate a current reference for a charge pump in accordance with the invention.

FIG. 6 is a schematic block diagram of a prophetic example of the system of FIG. 5.

FIG. 7 is a flowchart illustrating method aspects according to the invention.

FIG. 8 is a flowchart illustrating method aspects according to the method of FIG. 7.

FIG. 9 is a flowchart illustrating method aspects according to the method of FIG. 7.

FIG. 10 is a flowchart illustrating method aspects according to the method of FIG. 7.

FIG. 11 is a flowchart illustrating method aspects according to the method of FIG. 10.

FIG. 12 is a flowchart illustrating method aspects according to the method of FIG. 10.

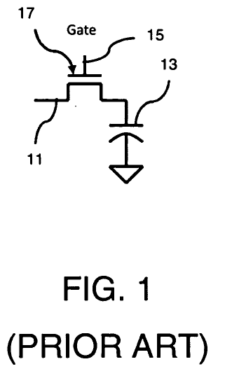

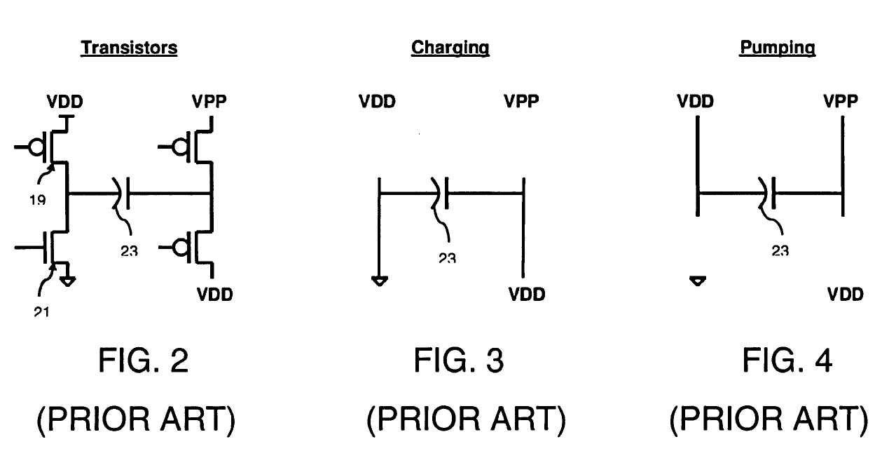

### DETAILED DESCRIPTION OF THE PREFERRED EMBODIMENTS

The invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout, and prime notation is used to indicate similar elements in alternative embodiments.

As will be appreciated by one skilled in the art, the invention may be embodied as a method, system, or computer program product. Furthermore, the invention may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, or a magnetic storage device.

Computer program code for carrying out operations of the invention may be written in an object oriented programming language such as Java, Smalltalk, C++ or the like. However, the computer program code for carrying out operations of the invention may also be written in conventional procedural programming languages, such as the “C” programming language or similar programming languages.

The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

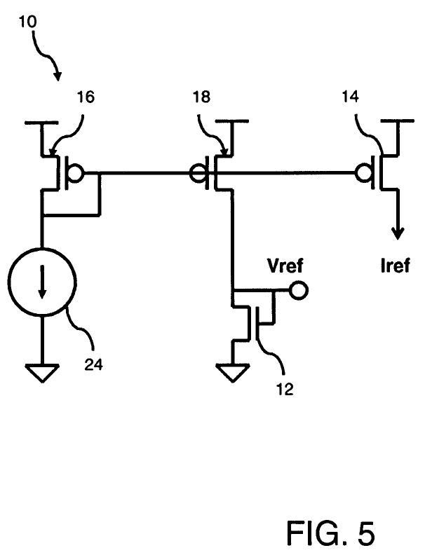

Referring to FIG. 5, a system 10 to generate a reference for a charge pump is now illustrated. The system 10 includes a diode-connected transistor 12 providing a reference voltage, and an output transistor 14, for example.

The system 10 also includes a reference circuit 16 to provide a current 24 that is substantially temperature insensitive and the reference circuit delivers the current across the diode-connected transistor 12 thereby enabling the reference voltage to move with processing of the diode-connected transistor, for instance.

In one embodiment, the system 10 further includes a mirroring circuit 18 to mirror the current 24 to the output transistor 14. In another embodiment, the mirroring circuit 18 comprises positive-type field-effect transistors.

The diode-connected transistor 12 comprises a field-effect transistor, for example. The diode-connected transistor 12 comprises a dynamic random access memory transistor, for instance. When the threshold voltage of the diode-connected transistor 12 changes, the reference voltage will change as well. This will directly change the output generated voltage as long as a direct comparison is made between the current and the reference voltage.

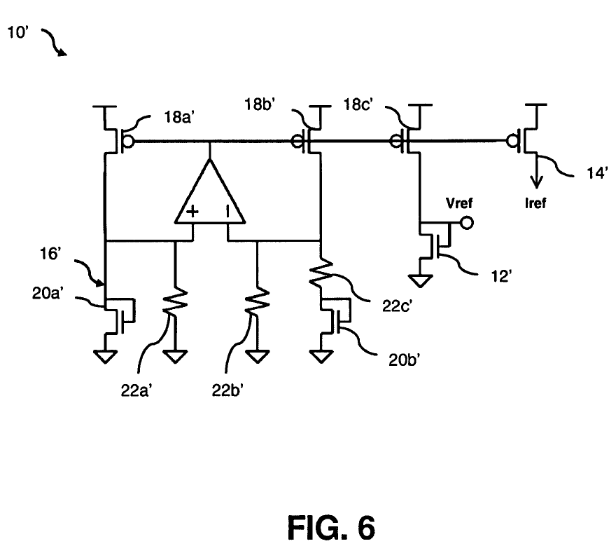

With additional reference to FIG. 6, one prophetic example of the system 10′ is now described. In this embodiment, the reference circuit 16′ comprises a bandgap arrangement of transistors 20a′ and 20b′ and a bandgap resistor 22c′, as well as a resistor 22a′ and 22b′ in parallel with each of the bandgap arrangement of transistors to reduce at least one of process, voltage, and temperature sensitivity of the current. In another embodiment, the reference circuit's 16′ bandgap arrangement of transistors 20a′ and 20b′ comprise negative-type transistors.

In yet another embodiment, the reference circuit's 16′ bandgap arrangement of transistors 20a′ and 20b′ and a bandgap resistor 22c′, as well as respective parallel resistors 22a′ and 22b′ may sum the current. The reference circuit's 16′ resistors 22a′ and 22b′ compensate for temperature dependence of transistor voltage thresholds of the bandgap arrangement of transistors 20a′ and 20b′ having a bandgap resistor 22c′, for example.

In one embodiment, the system 10′ further includes a mirroring circuit elements 18a′-18c′ to mirror the current to the output transistor 14′. In another embodiment, the mirroring elements 18a′-18c′ comprise positive-type field-effect transistors.

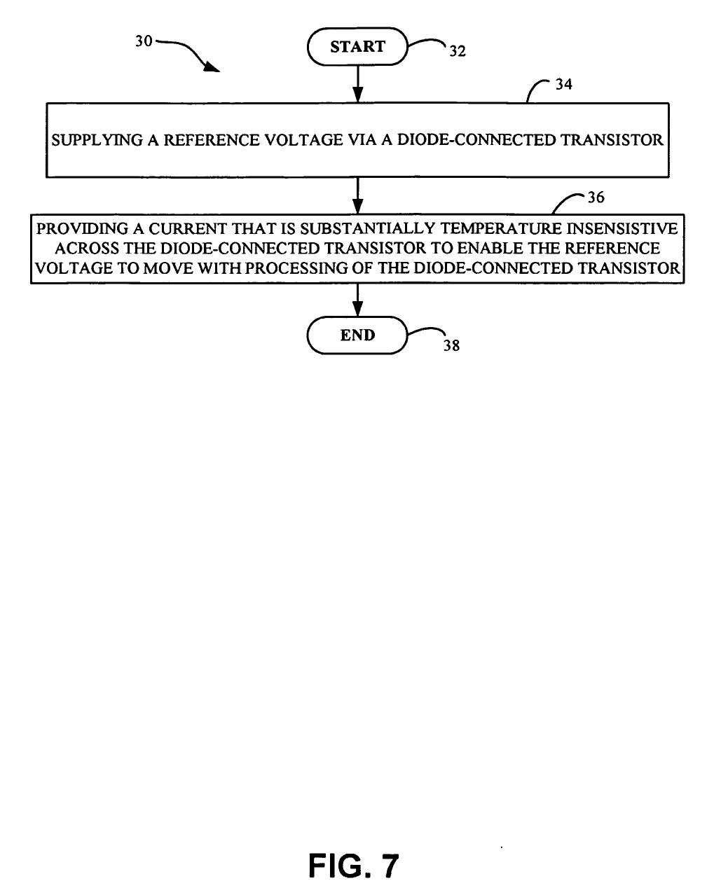

Another aspect of the invention is a method to generate a reference for a charge pump, which is now described with reference to flowchart 30 of FIG. 7. The method begins at Block 32 and may include supplying a reference voltage via a diode-connected transistor at Block 34. The method may also include providing a current that is substantially temperature insensitive across the diode-connected transistor to enable the reference voltage to move with processing of the diode-connected transistor at Block 36. The method ends at Block 38.

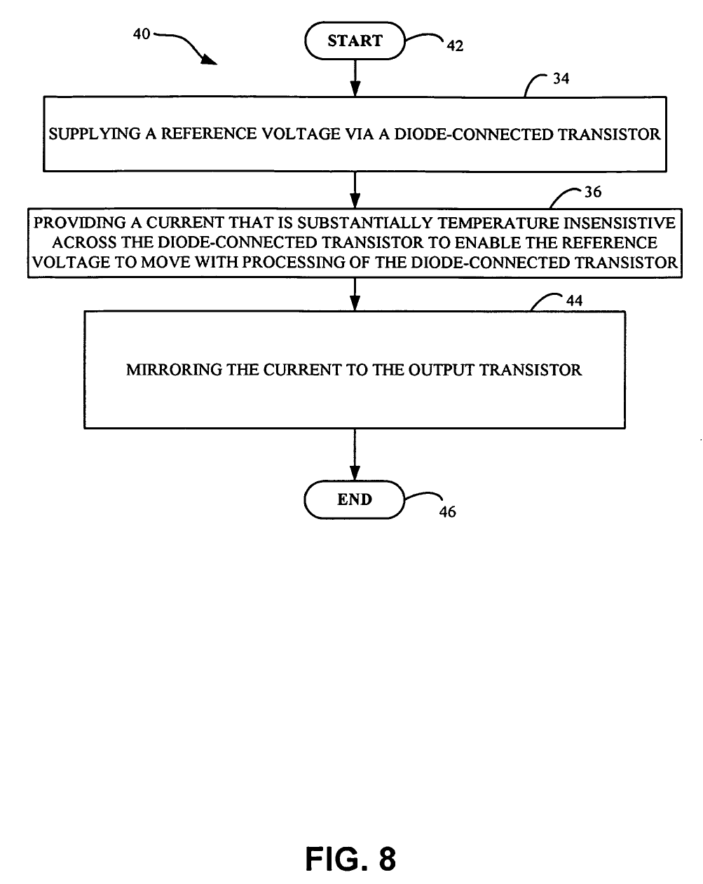

In another method embodiment, which is now described with reference to flowchart 40 of FIG. 8, the method begins at Block 42. The method may include the steps of FIG. 7 at Blocks 34 and 36. The method may also include mirroring the current to the output transistor at Block 44. The method ends at Block 46.

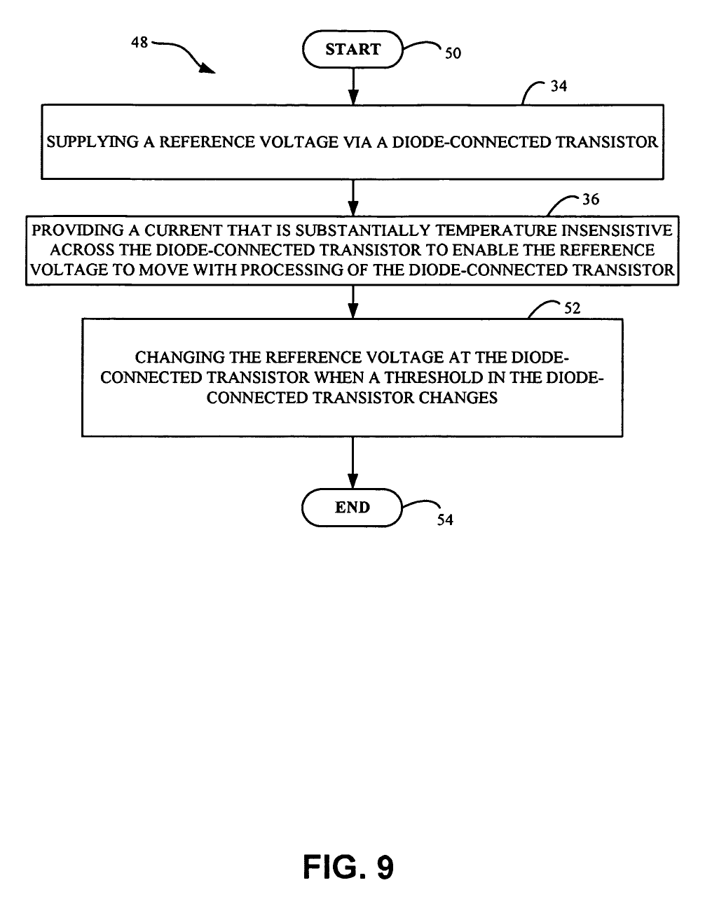

In another method embodiment, which is now described with reference to flowchart 48 of FIG. 9, the method begins at Block 50. The method may include the steps of FIG. 7 at Blocks 34 and 36. The method may also include changing the reference voltage at the diode-connected transistor when a threshold in the diode-connected transistor changes at Block 52. The method ends at Block 54.

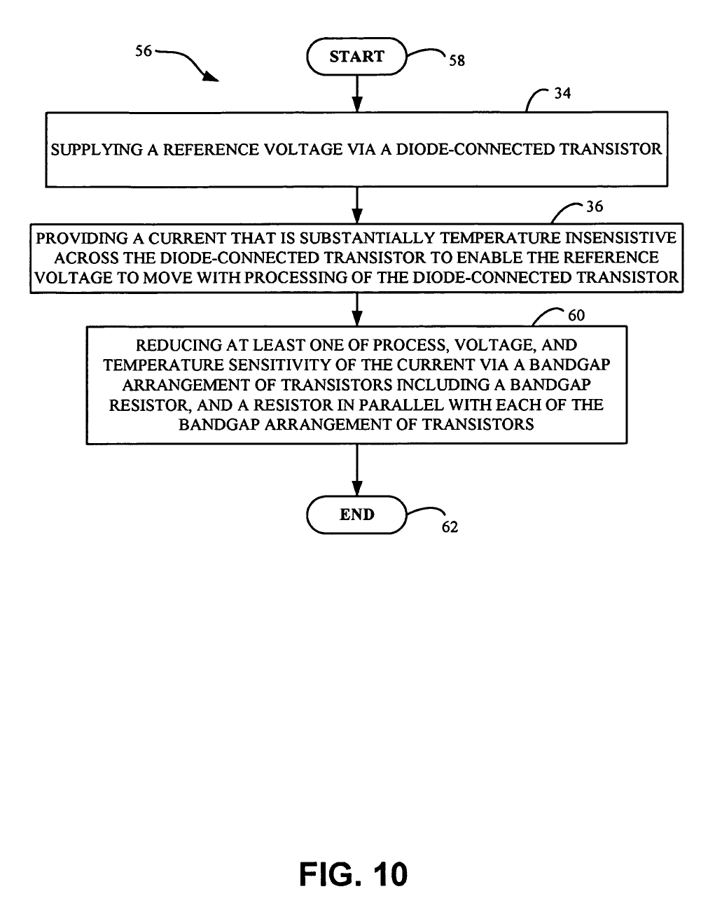

In another method embodiment, which is now described with reference to flowchart 56 of FIG. 10, the method begins at Block 58. The method may include the steps of FIG. 7 at Blocks 34 and 36. The method may additionally include reducing at least one of process, voltage, and temperature sensitivity of the current via a bandgap arrangement of transistors including a bandgap resesistor, and a resistor in parallel with each of the bandgap arrangement of transistors at Block 60. The method ends at Block 62.

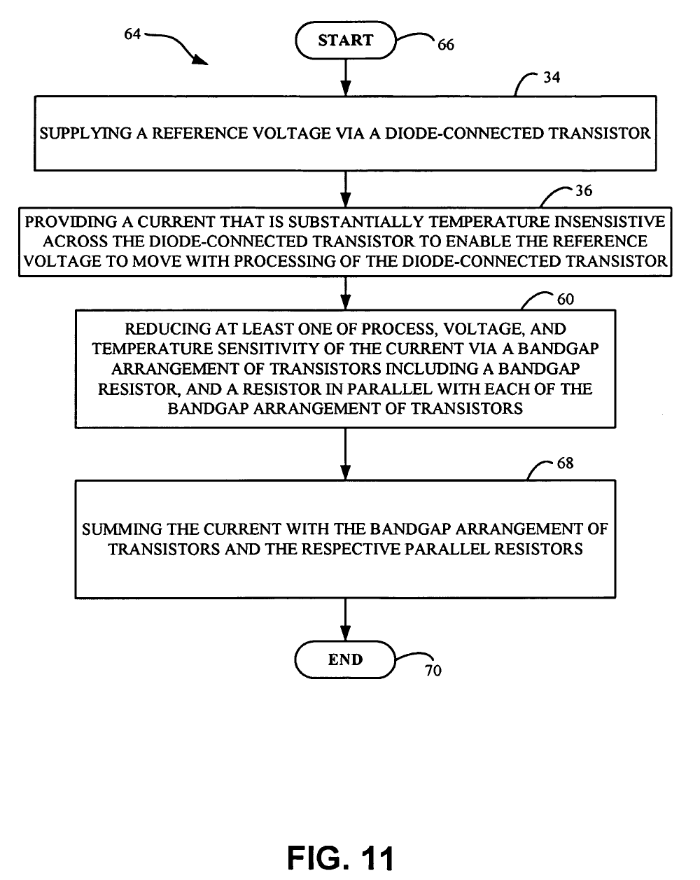

In another method embodiment, which is now described with reference to flowchart 64 of FIG. 11, the method begins at Block 66. The method may include the steps of FIG. 10 at Blocks 34, 36, and 60. The method may additionally include summing the current with the bandgap arrangement of transistors including a bandgap resesistor, and the respective parallel resistors at Block 68. The method ends at Block 70.

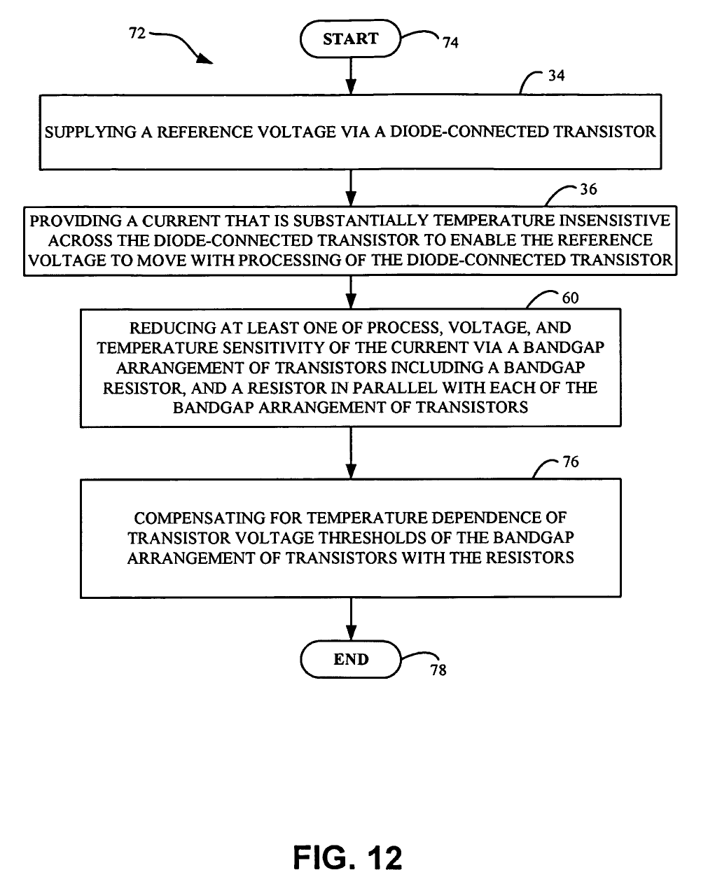

In another method embodiment, which is now described with reference to flowchart 72 of FIG. 12, the method begins at Block 74. The method may include the steps of FIG. 10 at Blocks 34, 36, and 60. The method may additionally include compensating for temperature dependence of transistor voltage thresholds of the bandgap arrangement of transistors including a bandgap resesistor, with the resistors at Block 76. The method ends at Block 78.

In view of the foregoing, the system 10 uses a current reference, rather than a voltage reference, and the current reference is applied across a copy of a DRAM transistor. As a result, the reference voltage will move with the processing of the DRAM transistor thereby increasing the range of the DRAM system. System 10 therefore provides a compensating reference for an embedded DRAM voltage generator. In addition, the current can be mirrored and sent to a charge pump circuit for use in detecting the output voltage accurately.

In contrast, known solutions for producing a reference typically use a bandgap generator. This kind of circuit also usually requires a large value of the power supply, which may not be present in modern semiconductor products. When used in an embedded DRAM circuit to boost the wordline driving potential, for example, the generated voltage will not be large enough if the transistors have a large nominal voltage threshold (“Vt”) or possibly too large if the Vt is very low.

The capabilities of the system 10 can be implemented in software, firmware, hardware or some combination thereof.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention. Furthermore, the use of the terms a, an, etc. do not denote a limitation of quantity, but rather denote the presence of at least one of the referenced item.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

1. A system to generate a reference for a charge pump, the system comprising:
a diode-connected transistor providing a reference voltage; and
a reference circuit to provide a current that is substantially temperature insensitive, and said reference circuit delivers the current across said diode-connected transistor thereby enabling the reference voltage to move with processing of said diode-connected transistor.

2. The system of claim 1 further comprising a mirroring circuit to mirror the current to an output transistor.

3. The system of claim 2 wherein said mirroring circuit comprises positive-type field-effect transistors.

4. The system of claim 1 wherein said diode-connected transistor comprises a field-effect transistor.

5. The system of claim 1 wherein said diode-connected transistor comprises a dynamic random access memory transistor.

6. The system of claim 1 wherein said reference circuit comprises a bandgap arrangement of transistors and a resistor in parallel with each of the bandgap arrangement of transistors to reduce at least one of process, voltage, and temperature sensitivity of the current.

7. The system of claim 6 wherein said reference circuit's bandgap arrangement of transistors comprise negative-type transistors.

8. The system of claim 6 wherein each of said reference circuit's bandgap arrangement of transistors and respective parallel resistors sum the current.

9. The system of claim 6 wherein said reference circuit's resistors compensate for temperature dependence of transistor voltage thresholds of the bandgap arrangement of transistors.

10. A method to generate a current reference for a charge pump, the method comprising:
supplying a reference voltage via a diode-connected transistor; and
providing a current that is substantially temperature insensitive across the diode-connected transistor to enable the reference voltage to move with processing of said diode-connected transistor.

11. The method of claim 10 further comprising mirroring the current to the output transistor.

12. The method of claim 10 further comprising changing the reference voltage at the diode-connected transistor when a threshold in said diode-connected transistor changes.

13. The method of claim 10 further comprising reducing at least one of process, voltage, and temperature sensitivity of the current via a bandgap arrangement of transistors including a bandgap resesistor, and a resistor in parallel with each of the bandgap arrangement of transistors.

14. The method of claim 13 further comprising summing the current with the bandgap arrangement of transistors including a bandgap resesistor, and the respective parallel resistors.

15. The method of claim 13 further comprising compensating for temperature dependence of transistor voltage thresholds of the bandgap arrangement of transistors including a bandgap resesistor, with the resistors.

16. A system to generate a current reference for a charge pump, the system comprising:
a field-effect diode-connected transistor providing a reference voltage;
an output transistor similar to said diode-connected transistor; and
a reference circuit to provide a current that is substantially temperature insensitive, and said reference circuit delivers the current across said diode-connected transistor thereby enabling the reference voltage to move with processing of said diode-connected transistor.

17. The system of claim 16 further comprising a mirroring circuit to mirror the current to said output transistor.

18. The system of claim 16 wherein said reference circuit comprises a bandgap arrangement of transistors and a resistor in parallel with each of the bandgap arrangement of transistors to reduce at least one of process, voltage, and temperature sensitivity of the current.

19. The system of claim 16 wherein each of said reference circuit's bandgap arrangement of transistors and respective parallel resistors sum the current.
